(19) United States
(12) Patent Application Publication
(10) Pub. No.: US 2025/0119777 A1
(43) Pub. Date: Apr. 10, 2025

(54) REDUCTION OF UNNECESSARY RADIO MEASUREMENT RELAXATION REPORTS

(71) Applicant: Telefonaktiebolaget LM Ericsson (publ), Stockholm (SE)

(72) Inventors: Mattias BERGSTRÖM, Sollentuna (SE); Tuomas TIRRONEN, Helsinki (FI)

(21) Appl. No.: 18/293,442

(22) PCT Filed: Jul. 22, 2022
(86) PCT No.: PCT/SE2022/050723

§ 371 Date: Jan. 30, 2024

Related U.S. Application Data
(60) Provisional application No. 63/229,225, filed on Aug. 4, 2021.

(51) Int. Cl. H04W 24/10

(52) U.S. Cl. CPC H04W 24/10

(57) ABSTRACT

A method of operating a wireless device in a communication network includes determining that a criterion associated with radio measurement relaxation has been met for a continuous time to trigger, TTT, duration, wherein the continuous TTT duration is greater than zero, and, in response to determining that the criterion associated with radio measurement relaxation has been met for the continuous TTT duration, transmitting a radio measurement relaxation report to a radio access network, RAN, node indicating that the criterion associated with radio measurement relaxation has been met.

### TECHNICAL FIELD

The present disclosure relates generally to communications, and more particularly to communication methods and related devices and nodes supporting wireless communications.

### BACKGROUND

Referring to FIG. 1, a wireless communication system typically includes a base station 10 that communicates with a mobile wireless device 20, sometimes referred to as a user equipment, or UE 20. The base station 10 receives uplink communications 22 from the UE 10 and transmits downlink communications 24 to the UE 20.

The 5G wireless standard, which is the fifth generation of cellular technology, is designed to increase speed, reduce latency, and improve flexibility of wireless services. A 5G system (5GS) includes both a new radio access network (NG-RAN) which makes use of a new air interface called New Radio (NR), and a new core network (5GC).

The initial release of 5G in Release 15 is optimized for mobile broadband (MBB) and ultra-reliable and low latency communication (URLLC). These services require very high data rates and/or low latency and therefore puts high requirements on the UE. To enable 5G to be used for other services with more relaxed performance requirements a new low complexity UE type is introduced in Release 17, called ‘reduced capability NR devices’ or ‘RedCap.’ The low complexity UE type is particularly suited for machine type communication (MTC) services, such as wireless sensors or video surveillance, but it can also be used for MBB services with lower performance requirements such as wearables. The low complexity UE has reduced capabilities compared to a Release 15 NR UE such as possibility to support lower bandwidth compared to what is currently required for a NR UE and possibility to support only one reception (Rx) branch and one MIMO layer.

When an NR device is in RRC CONNECTED mode, it may be configured to perform radio resource management (RRM) measurements. RRM measurements include, for example, measurements of signal strength at the UE. The UE can be configured to report such measurements to the network.

RRM measurements may consume UE power due to the need to perform measurement and also the reporting of those measurements. Hence it is discussed in 3GPP to introduce relaxed RRM measurements in CONNECTED mode. The measurement requirements may be relaxed, for example, by decreasing the frequency at which the UE needs to perform a measurement.

Relaxed RRM measurements may save some UE energy. However, they may at the same time reduce the accuracy of the measurements. Moreover, some measurements may never be performed or sent to the network. Hence the RRM measurement relaxation should only be performed when certain conditions are met.

It has been discussed that the UE shall monitor certain conditions and report to the network when they are fulfilled and not. One possible condition is that the UE-measured reference signal received power (RSRP) is above a certain threshold. In response to such a report, the network may configure the UE to perform RRM measurement relaxation. Two have been discussed. In a first approach, the network explicitly indicates that the UE shall apply a relaxed RRM measurement behavior (the behavior would likely be specified in a specification, e.g. that the frequency of the measurements is reduced). In a second approach, the network reconfigures the RRM measurement configuration for the UE. For example, the network may deconfigure measurements on some frequencies, or the periodicity of RRM measurement reporting may be increased, etc.

There currently exist certain challenge(s). The report for fulfillment and unfulfillment of the criteria/conditions for RRM measurement relaxation costs both radio resources and costs UE power consumption to send. If the UE sends such reports as soon as the conditions are fulfilled and as soon as the conditions no longer are fulfilled, it may result in that the UE sends unnecessary reports.

### SUMMARY

A method of operating a wireless device in a communication network includes determining that a criterion associated with radio measurement relaxation has been met for a continuous time to trigger, TTT, duration, wherein the continuous TTT duration is greater than zero, and in response to determining that the criterion associated with radio measurement relaxation has been met for the continuous TTT duration, transmitting a radio measurement relaxation report to a radio access network, RAN, node indicating that the criterion associated with radio measurement relaxation has been met.

In some embodiments, the radio measurement relaxation report is sent by the wireless device when the criterion has been fulfilled for a continuous period of time and when the wireless device has not previously sent a positive radio measurement relaxation report indicating fulfillment of the criterion or a radio measurement relaxation report that was most recently sent by the wireless device was a negative report indicating unfulfillment of the criterion.

The criterion may be a received power level and/or received quality level of a reference signal transmitted by the RAN node being greater than a threshold value.

The method may further include, in response to transmitting the measurement relaxation report, receiving a command from the RAN node changing a measurement configuration of the UE.

The method may further include, in response to transmitting the measurement relaxation report, receiving a command from the RAN node which may indicate that the wireless device should commence radio measurement relaxation, and commencing radio measurement relaxation in response to receiving the command.

The command may include a radio measurement relaxation configuration.

In some embodiments, after determining that the criterion associated with radio measurement relaxation has been met for the continuous TTT duration, transmitting the radio measurement relaxation report is only performed if a last radio measurement relaxation report transmitted by the wireless device indicated that the criterion was not fulfilled.

In some embodiments, after determining that the criterion associated with radio measurement relaxation has been met for the continuous TTT duration, transmitting the radio measurement relaxation report is only performed if the wireless device did not already transmit a previous radio measurement relaxation report indicating fulfillment of the criterion.

The criterion may be an unfulfillment criterion that may indicate that the wireless device is in a state that is unsuitable for radio measurement relaxation.

The unfulfillment criterion may include a received power level and/or received quality level of a reference signal transmitted by the RAN node being lower than a threshold value.

The method may further include, in response to transmitting the measurement relaxation report, receiving a command from the RAN node indicating that the wireless device should cease radio measurement relaxation, and ceasing radio measurement relaxation in response to receiving the command.

Transmitting the radio measurement relaxation report may only performed if a last radio measurement relaxation report transmitted by the wireless device indicated that a fulfillment criterion that may indicate that the wireless device is in a state that is suitable for radio measurement relaxation was met

The method may further include, in response to transmitting the measurement relaxation report, receiving a command from the RAN node changing the measurement configuration of the UE.

The radio measurement relaxation may include radio resource management, RRM, measurement relaxation.

A method of operating a wireless device in a communication network according to further embodiments includes monitoring a network parameter to determine whether a fulfillment criterion or an unfulfillment criterion associated with radio measurement relaxation has been met, and transmitting a radio measurement relaxation report to a network node in response to determining that the fulfillment criterion or the unfulfillment criterion has been met. The fulfillment criterion may be the network parameter being greater than a first threshold, and the unfulfillment criterion may be the network parameter being less than a second threshold, wherein the first threshold is greater than the second threshold.

The network parameter may include a power level and/or quality of a reference signal received by the wireless device.

In response to determining that the fulfillment criterion has been met, the radio measurement relaxation report may indicate that the fulfillment criterion has been met.

The method may further include, in response to transmitting the measurement relaxation report, receiving a command from the RAN node indicating that the wireless device should commence radio measurement relaxation, and commencing radio measurement relaxation in response to receiving the command.

In response to determining that the unfulfillment criterion has been met, the radio measurement relaxation report may indicate that the unfulfillment criterion has been met.

The method may further include, in response to transmitting the measurement relaxation report, receiving a command from the RAN node indicating that the wireless device should cease radio measurement relaxation, and ceasing radio measurement relaxation in response to receiving the command.

The first threshold is defined as a first delta h1 above a nominal threshold X and the second threshold is defined as a second delta h2 below the nominal threshold X.

In some embodiments, the first delta h1 and the second delta h2 are a same value, and in some embodiments, the first delta h1 and the second delta h2 are different values.

The fulfillment criterion further may include a difference between successive measurements of the network parameter being greater than a threshold difference.

The unfulfillment criterion further may include a difference between successive measurements of the network parameter being greater than a threshold difference.

The method may further include, in response to determining that the fulfillment criterion or the unfulfillment criterion has been met, starting a time-to-trigger, TTT, timer,
wherein transmitting the radio measurement relaxation report to the network node is performed only if the fulfillment criterion or unfulfillment criterion persists for the duration of the TTT timer.

The method may further include, after determining that the fulfillment criterion has been met, refraining from sending further radio measurement relaxation reports until the unfulfillment criterion has been met, and vice-versa.

The method may further include refraining from sending a radio measurement relaxation report to the network node indicating that the unfulfillment criterion has been met unless the wireless device has previously transmitted a radio measurement relaxation report to the network node indicating that the fulfillment criterion has been met.

In some embodiments, the previously transmitted radio measurement relaxation report was transmitted while the wireless device was in a same configuration state.

The method may further include refraining from sending additional radio measurement relaxation reports for a defined period of time after transmitting an earlier radio measurement relaxation report to the network node.

In some embodiments, the earlier relaxation report indicated that the fulfillment or the unfulfillment criterion had been met, and refraining from sending the additional radio measurement relaxation reports includes refraining from sending additional radio measurement relaxation reports indicating that the fulfillment criterion has been met.

Radio measurement relaxation may include radio resource management, RRM, measurement relaxation.

A method of operating a wireless device in a communication network according to further embodiments includes monitoring a network parameter to determine whether a fulfillment criterion or an unfulfillment criterion associated with radio measurement relaxation has been met, transmitting a measurement relaxation report to a network node in response to determining that the fulfillment criterion or the unfulfillment criterion has been met, and refraining from sending additional measurement relaxation reports for a defined period of time after transmitting the radio measurement relaxation report to the network node.

In some embodiments, the radio measurement relaxation report indicated that the fulfillment or the unfulfillment criterion had been met, and refraining from sending the additional radio measurement relaxation reports may include refraining for the defined period of time from sending additional radio measurement relaxation reports indicating that the fulfillment criterion has been met.

A method of operating a wireless device in a communication network according to further embodiments includes monitoring a network parameter to determine whether a fulfillment criterion or an unfulfillment criterion associated with radio measurement relaxation has been met, and transmitting a radio measurement relaxation report to a network node in response to determining that the fulfillment criterion or the unfulfillment criterion has been met, and after determining that the fulfillment criterion has been met, refraining from sending further radio measurement relaxation reports until the unfulfillment criterion has been met, and vice-versa.

The fulfillment criterion may include the network parameter being greater than a first threshold, and the unfulfillment criterion may include the network parameter being less than a second threshold, wherein the first threshold is greater than the second threshold.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a diagram illustrating elements of a radio access network.

FIGS. 2 to 15 are example graphs of a measured parameter that is used to trigger RRM measurement relaxation reporting as a function of time.

FIGS. 16 to 18 are block diagrams illustrating operations of wireless devices according to various embodiments.

FIG. 19 is a block diagram illustrating a wireless device UE according to some embodiments of inventive concepts.

FIG. 20 is a block diagram of a communication system in accordance with some embodiments.

FIG. 21 is a block diagram of a user equipment in accordance with some embodiments.

FIG. 22 is a block diagram of a network node in accordance with some embodiments.

FIG. 23 is a block diagram of a host computer communicating with a user equipment in accordance with some embodiments.

FIG. 24 is a block diagram of a virtualization environment in accordance with some embodiments.

FIG. 25 is a block diagram of a host computer communicating via a base station with a user equipment over a partially wireless connection in accordance with some embodiments in accordance with some embodiments.

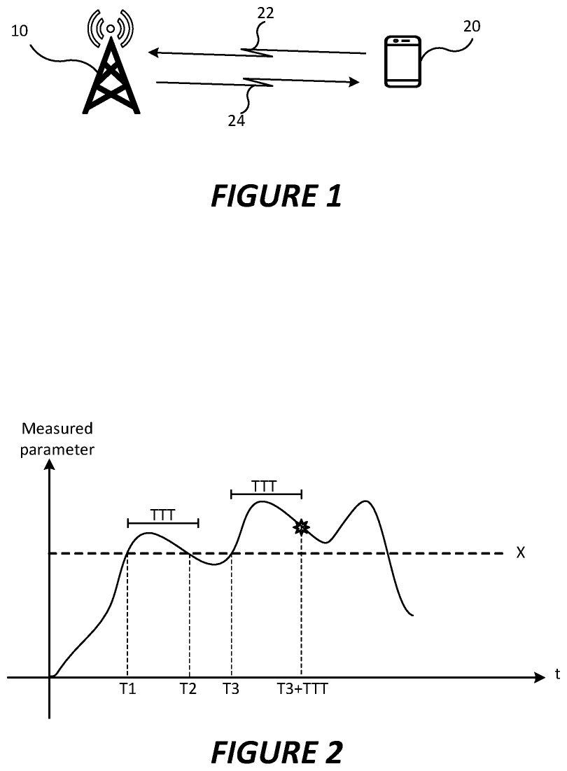

### DETAILED DESCRIPTION

Certain aspects of the disclosure and their embodiments may provide solutions to these or other challenges. In particular, some embodiments described herein provide methods to ensure that the UE sends timely indications of fulfillment or RRM measurement relaxation criteria/conditions, while avoiding sending unnecessary indications to the network. Some embodiments use various approaches, such as applying a time to trigger for the RRM measurement relaxation fulfillment-report, applying a hysteresis for determining when to send the RRM measurement relaxation fulfillment-report, avoiding sending a report with the same value as already indicated, avoiding indicating unfulfillment of conditions without having indicated fulfillment earlier, and/or applying a prohibit timer for sending the report.

Certain embodiments may provide one or more of the following technical advantage(s). In particular, by employing one or more such approaches, a UE may send timely reports to the network about RRM measurement relaxation criteria/condition fulfillment/unfulfillment, while avoiding sending unnecessary reports.

Some of the embodiments contemplated herein will now be described more fully with reference to the accompanying drawings. Embodiments are provided by way of example to convey the scope of the subject matter to those skilled in the art., in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment. In the following description, the term “RRM measurement relaxation” refers to mechanisms which enable a UE to reduce RRM measurements in a specified way or as configured by the network.

### Time to Trigger Embodiments

In some embodiments, a UE may determine a time T when a criterion for RRM measurement relaxation is fulfilled, or a time T when the criterion for RRM measurement relaxation is unfulfilled. If the criterion is still fulfilled for a time TTT after it became fulfilled/unfulfilled (i.e., the criterion remains fulfilled/unfulfilled at time T+TTT), the UE sends a report to the network indicating fulfillment/unfulfillment of the criterion. The UE may send the report only if the criterion has been fulfilled/unfulfilled during the whole time-duration of TTT. Otherwise, e.g. if the criterion has not been continuously fulfilled/unfulfilled during the time duration TTT, the UE does not send the report. This may be implemented by a timer which is started upon fulfilling or not fulfilling the criteria at time T and if the criteria remains fulfilled or unfulfilled during the timer duration, the UE sends the report. The timer may be referred to as a time-to-trigger timer.

The use of a time-to-trigger timer may ensure that the UE will not send the report if the criteria gets fulfilled suddenly, and shortly after triggering the criteria becomes unfulfilled again. This may allow the network to avoid having to repeatedly configure/deconfigure the RRM measurement relaxation behavior, which costs signalling overhead.

FIG. 2 is an example graph of a measured parameter that is used to trigger RRM measurement relaxation reporting as a function of time with a time-to-trigger requirement. The measured parameter may be a reference signal received power (RSRP) or reference signal received quality (RSRQ) measurement obtained by a UE. A threshold value X of the measured parameter is used to determine whether an RRM measurement relaxation report should be sent to the network. As shown in the example of FIG. 2, the value of the measured parameter exceeds the threshold X at time T1. However, the value of the measured parameter falls below the threshold X at time T2, which is less than T1+TTT. Thus, in these embodiments, an RRM measurement relaxation report would not be sent at that time. At time T3, the value of the measured parameter exceeds the threshold X and remains above the threshold X for the duration of TTT. Thus, in this example, at time T3+TTT, the UE would send an RRM measurement relaxation report to the network, as indicated by the star.

### Hysteresis Embodiments

In some embodiments, the UE may consider the criterion for sending the report indicating fulfillment of a RRM measurement relaxation criterion if the criterion is fulfilled by more than a predetermined threshold. As noted above, an RRM measurement relaxation threshold may include a RSRP measurement. Thus, a UE may consider the criterion for sending the report indicating fulfillment of a RRM measurement relaxation criterion only after the RSRP exceeds a threshold value by more than a predetermined threshold. The predetermined threshold is referred to as a hysteresis value.

For example, if the RRM measurement relaxation criterion is considered fulfilled if the signal strength is above a threshold X, the UE may only send a report indicating fulfillment of the threshold if the signal strength is above X+h1, where the value h1 is a hysteresis value.

The UE may further consider the criterion for sending the report indicating unfulfillment of an RRM measurement relaxation criterion if the measured quantity falls below a threshold by more than a hysteresis value. For example, if the criterion is considered unfulfilled when the signal strength falls below a threshold X, the UE may only report the unfulfillment condition if the signal strength is less than X-h2, where the value h2 is a hysteresis value.

Also, it has been described above that there is a first hysteresis value applied for determining when to send the fulfillment report (h1 above), and a second hysteresis value for determining when to send the unfulfillment report (h2 above). However, if would be possible to use only one value h which is used to determine when to report fulfillment and unfulfillment. In one configuration example both h1 and h2 and defined in the specification but either h1 or h2 is set to zero or absent in configuration, in practice meaning only the other hysteresis threshold is used.

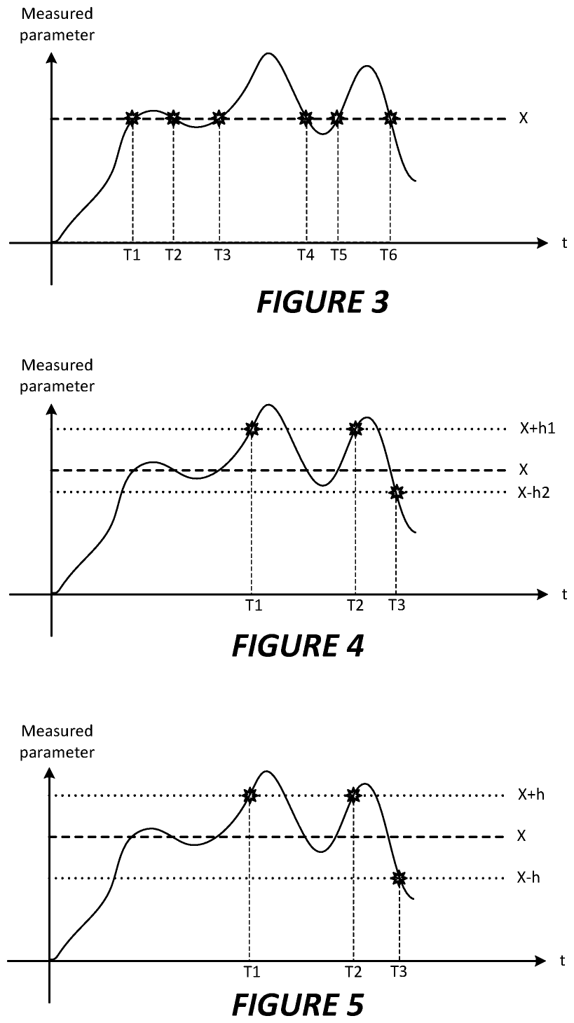

FIG. 3 is an example graph of a measured parameter that is used to trigger RRM measurement relaxation reporting as a function of time without hysteresis. A threshold X is shown. Each time the value of the measured parameter passes the threshold X, an RRM measurement relaxation report is triggered. At time T1, the threshold becomes fulfilled and the UE sends a report to the network indicating fulfillment. At time T2, the threshold becomes unfulfilled and the UE sends a report to the network indicating unfulfillment, and so on. As can be seen, if the UE signal strength is hovering close to the threshold X, the UE may send reports of fulfillment/unfulfillment frequently, which may require excessive signalling overhead and result in unnecessary enabling/disabling of the RRM measurement relaxation feature for the UE.

FIG. 4 is an example graph of a measured parameter that is used to trigger RRM measurement relaxation reporting as a function of time with hysteresis. In the example shown in FIG. 4, an upper hysteresis value h1 and a lower hysteresis value h2 are configured along with a threshold value X. The values of h1 and h2 may be different as shown in FIG. 4, or they may be the same. In these embodiments, an RRM measurement relaxation report indicating fulfillment is not triggered until the value of the measured parameter exceeds X+h1. Likewise, an RRM measurement relaxation report indicating unfulfillment is not triggered until the value of the measured parameter falls below X-h2.

As can be seen in FIG. 4, the UE does not send as many reports and instead only sends a report when the criteria are fulfilled with values above or below the original threshold X according to the values of the hysteresis parameters. In this example there is just a single threshold X with two (different) hysteresis values. Accordingly, in this example, RRM measurement relaxation reports indicating fulfillment are triggered at times T1 and T2, while an RRM measurement relaxation report indicating unfulfillment is triggered at time T3. In some embodiments, an RRM measurement relaxation report would only be triggered if the condition status changed from a previous status. For example, an RRM measurement relaxation report indicating fulfillment would not be sent twice in a row. In such embodiments, still referring to FIG. 4, an RRM measurement relaxation report indicating fulfillment would not be sent at time T2 since the previous RRM measurement relaxation report at time T1 indicated fulfillment.

FIG. 5 is another example graph of a measured parameter that is used to trigger RRM measurement relaxation reporting as a function of time with hysteresis. In the example shown in FIG. 5, a single hysteresis value h is configured along with a threshold value X. In these embodiments, an RRM measurement relaxation report indicating fulfillment is not triggered until the value of the measured parameter exceeds X+h. Likewise, an RRM measurement relaxation report indicating unfulfillment is not triggered until the value of the measured parameter falls below X-h.

Another possible way to achieve the same thing as the hysteresis described above is that the UE considers the condition for sending the fulfillment report when the signal strength is above a first threshold X, and considers the condition for sending the unfulfillment report when the signal strength is below a second threshold Y.

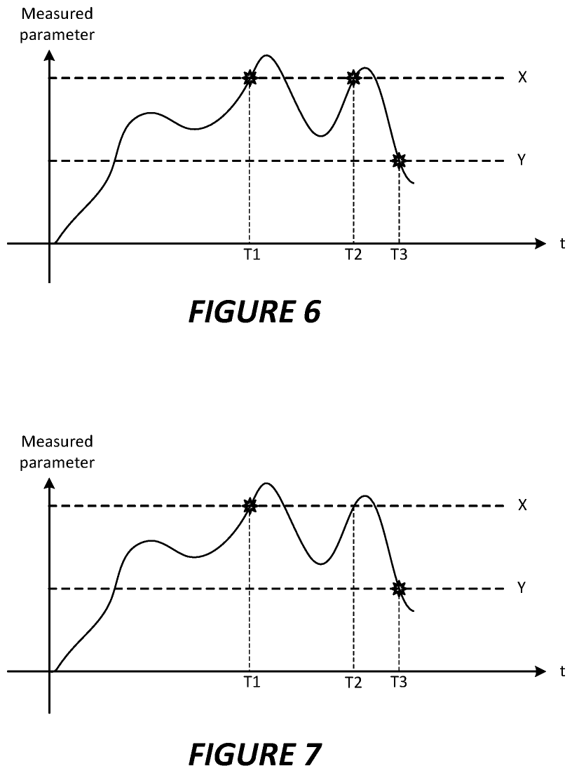

FIG. 6 is an example graph of a measured parameter that is used to trigger RRM measurement relaxation reporting as a function of time with two thresholds. In the example shown in FIG. 6, an upper threshold value X and a lower threshold value Y are configured. In these embodiments, an RRM measurement relaxation report indicating fulfillment is not triggered until the value of the measured parameter exceeds X, while an RRM measurement relaxation report indicating unfulfillment is not triggered until the value of the measured parameter falls below Y.

In some embodiments, an RRM measurement relaxation report would only be triggered if the condition status changed from a previous status. For example, an RRM measurement relaxation report indicating fulfillment would not be sent twice in a row. In such embodiments, referring to FIG. 7, an RRM measurement relaxation report indicating fulfillment would not be sent at time T2 since the previous RRM measurement relaxation report at time T1 indicated fulfillment.

Accordingly, in some embodiments, the UE would not send a report indicating fulfillment of the criterion if the last sent report indicated fulfillment of the criterion. Likewise, if the last sent report indicated unfulfillment, the UE would not send a report indicating unfulfillment. Instead, the UE would only send a report indicating fulfilment if the last sent report indicated unfulfillment, and vice versa.

These embodiments have the benefit that the UE would avoid sending unnecessary reports, as the network already knows that the UE is fulfilling the conditions based on the previous report. However, the UE will later send a new report indicating that the UE no longer fulfills the criterion as the signal strength falls below threshold Y.

If the UE has been reconfigured with one or more parameters associated with RRM measurement relaxation (for example a threshold), the UE may consider that it can send any type of report. For example, if the network changed a parameter for the reporting, the UE may report that it fulfills the RRM measurement relaxation criteria even if the last sent report indicated fulfillment.

In some embodiments, the UE may not send a report to the network indicating that unfulfillment of the conditions for RRM measurement relaxation unless the UE has previously sent a report which indicated fulfillment of the conditions for RRM measurement relaxation. Thus, when RRM measurement relaxation fulfillment reporting is initially configured for the UE, the UE would not have sent any report about fulfillment or unfulfillment. The UE would therefore not send a report to indicate unfulfillment even if the condition to send such a report is met. In that case, the network may assume that the UE does not fulfill the conditions unless the UE has explicitly indicated the opposite. Hence, these embodiments may ensure that the UE does not send an unnecessary report indicating that the UE does not fulfill the RRM measurement relaxation conditions.

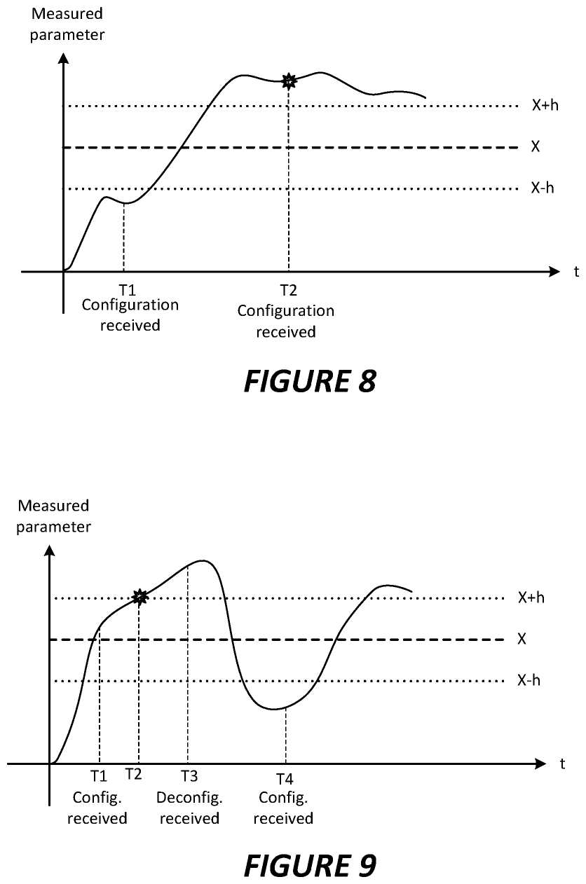

For example, referring to FIG. 8, the UE receives a configuration from the network at time T1 to send indications about RRM measurement relaxation fulfillment. The UE does not fulfill the conditions for RRM measurement relaxation at time T1, and refrains from sending a report at T1 (which, if sent, would have indicated that the UE does not fulfill the RRM measurement relaxation conditions).

Continuing with the example, the UE receives a configuration from the network at time T2 to send indications about RRM measurement relaxation fulfillment, where the UE fulfills the conditions for RRM measurement relaxation at time T2. Therefore, the UE sends a report at time T2 which indicates that the UE fulfills the conditions for RRM measurement relaxation.

In some embodiments, when the UE receives a configuration from the network to report the fulfillment/unfulfillment of RRM measurement relaxation criteria, the UE may not consider potential earlier reports it might have sent during a previous time it was configured with the reporting. For example, referring to FIG. 9, a UE is configured to send indications about RRM measurement relaxation fulfillment at time T1. The UE fulfills the conditions for RRM measurement relaxation and sends a report at time T2, and hence sends a report indicating this. The network deconfigures the UE from sending RRM measurement relaxation fulfillment reports at time T3. The network (again) configures the UE to send RRM measurement relaxation fulfillment reports at time T4. The UE does not fulfill the conditions for RRM measurement relaxation at time T4. The UE will refrain from sending a report even if the last sent report from the UE (the one sent at time T2) indicated that the UE fulfilled the RRM measurement relaxation criteria.

In some embodiments, the UE may be configured with a prohibit timer which, when running, prohibits the UE from sending another report for RRM measurement relaxation. This timer may be started in response to sending the report and while it runs the UE cannot send another report.

In some versions of this embodiment, the prohibit timer may be stopped in case the network reconfigures a parameter of the UE that is associated with the RRM measurement relaxation reporting feature, for example, reconfigures a threshold used by the UE to determine when to send the report, etc.

In some versions of this embodiment, the UE may stop the prohibit timer in the event the network indicates that the UE shall relax (or stop to relax) the RRM measurements. The UE may consider that the network has indicated that the UE shall relax the RRM measurements if, for example, the network sends an explicit indication to the UE to start (or stop) to apply relaxed RRM measurement behavior. Another approach is that the UE considers that the network has indicated that the UE shall relax (or stop to relax) RRM measurements if the network configures (or deconfigures) certain RRM measurements for the UE, or changes some other aspect of the RRM measurement configuration (e.g. periodicity of measurements).

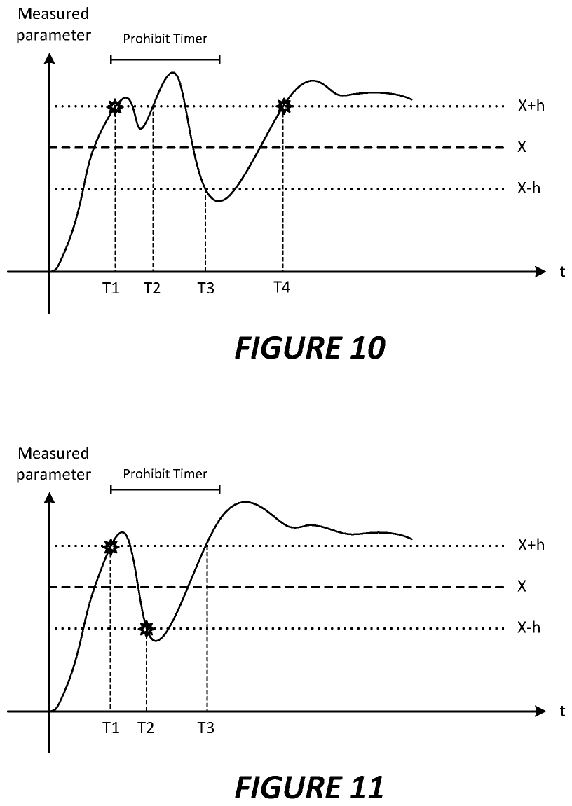

For example, referring to FIG. 10, an RRM measurement relaxation condition is fulfilled at time T1, and the UE sends a report indicating fulfillment to the network. The UE then starts a prohibit timer. While the prohibit timer is running, at time T2 the RRM measurement relaxation condition again becomes fulfilled, and then at time T3 the RRM measurement relaxation condition becomes unfulfilled. However, since the prohibit timer is still running, the UE does not send a fulfillment/unfulfillment report in response to either occurrence. At time T4, the RRM measurement relaxation condition again becomes fulfilled. Since T4 is outside the duration of the prohibit timer, the UE sends a fulfillment report at T4.

In some embodiments, the prohibit timer only applies for sending a report indicating fulfillment of the RRM measurement relaxation condition, but unfulfillment of the conditions would not be impacted. In other words, the prohibit timer may stop the UE from sending a report indicating that the UE fulfills the RRM measurement relaxation conditions, but it would not stop the UE from sending a report that it does not fulfills the conditions. This approach may be beneficial since a report indicating that the UE no longer fulfills the criteria may be considered urgent and shall not be blocked by a prohibit timer. The reason is that the network may in such a case urgently need to deconfigure the RRM measurement relaxation behavior for the UE. This is illustrated in FIG. 11. As shown therein, an RRM measurement relaxation condition is fulfilled at time T1, and the UE sends a report indicating fulfillment to the network. The UE then starts a prohibit timer. While the prohibit timer is running, at time T2 the RRM measurement relaxation condition becomes unfulfilled. Even though the prohibit timer is running, the UE sends an unfulfillment report to the network.

### Combination of Triggering Conditions

In some embodiments, different combinations of the embodiments described above may be used at the same time. If multiple triggering mechanisms or conditions are configured, in one example all of the conditions need to be fulfilled (i.e. conditions would be combined with logical AND operation). In another example fulfillment of individual condition would be enough (i.e. conditions would be combined with logical OR operation). It can also be possible to combine different conditions in other ways with logical AND and OR.

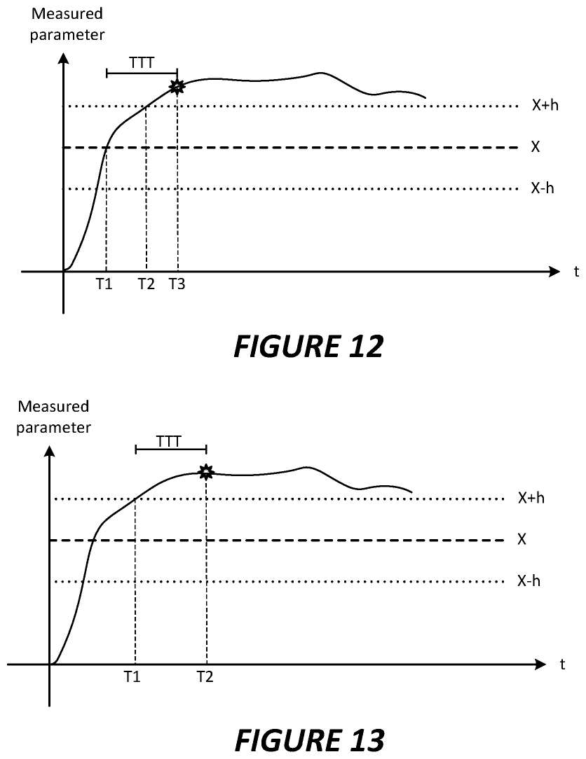

For example, referring to FIG. 12, both time-to-trigger and hysteresis may be configured and both conditions need to be fulfilled (logical AND) before the UE will send an RRM measurement relaxation report. The UE fulfills the condition for RRM measurement relaxation at time T1 when the signal strength is above X but not above hysteresis threshold X+h1. The UE starts a timer TTT. The UE signal strength becomes larger than X+h1 at time T2 (where T2<T1+TTT). Both conditions are not yet fulfilled, as the TTT timer has not yet expired. The UE signal strength is continuously over X+h1 until T3, where T3>T1+TTT. Now the UE fulfills both of the configured configurations and sends the fulfillment report. Thus, at time T3, once the TTT timer has expired, the UE sends an RRM measurement relaxation report to the network.

Alternatively, referring to FIG. 13, the TTT timer may not be started until the measured parameter exceeds the hysteresis threshold X+h1 at time T1. At time T2, once the TTT timer has expired, the UE sends an RRM measurement relaxation report to the network.

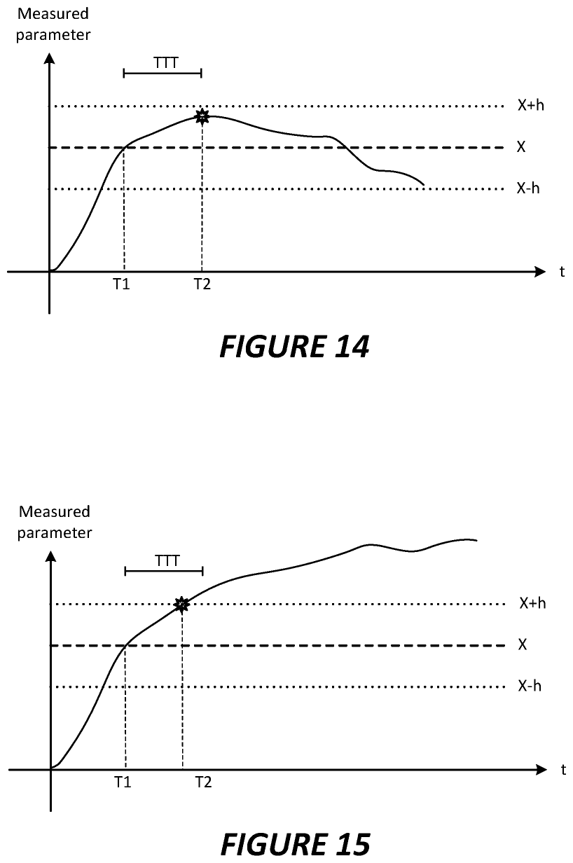

In some embodiments, an RRM measurement relaxation report may be sent when either of the conditions is fulfilled (logical OR). For example, referring to FIG. 14, the UE may start the TTT timer when the UE fulfills the conditions for RRM measurement relaxation at time T1 when the measured parameter is above X but not above the hysteresis threshold X+h1. When the timer expires at time T2=T1+TTT, the UE may send an RRM measurement relaxation report even though the measured parameter is still below the hysteresis threshold X+h1.

Likewise, referring to FIG. 15, the UE may start the TTT timer when the UE fulfills the conditions for RRM measurement relaxation at time T1 when the measured parameter is above X but not above the hysteresis threshold X+h1. When the measured parameter exceeds the hysteresis threshold X+h1, the UE may send an RRM measurement relaxation report even though the TTT timer has not yet expired.

It has been described above how the UE applies certain parameters and configurations, such as time to trigger values, hysteresis values, timer values, thresholds etc. These parameters may be provided to the UE from the network, for example, using dedicated RRC signalling. Another approach is that the parameters may be broadcasted, and the UE applies those values. A third approach is that the parameters are specified, e.g. hardcoded in a specification. Moreover, a mix of these options are possible. For example, some of the parameters/configurations may be configured for the UE using dedicated RRC signalling, while some may be configured for the UE using broadcast signalling, and some may be preconfigured for the UE (e.g. hardcoded in a specification).

In case there are multiple options of configuring a certain parameter for the UE, e.g. it is possible to configure a parameter using dedicated signalling and also using broadcast signalling, the UE may consider a priority between these possible configuration options. One beneficial approach is that dedicated signalling takes precedence over broadcast signalling which takes precedence over specified values.

In some embodiments, it is possible for the UE to request or suggest specific values for the parameters and configurations for RRM measurement relaxation triggering. In one example such information is provided in UE assistance information RRC message from the UE to the network. In the example, the assistance information RRC message would be extended to include the relevant parameters the UE communicates to the network. The network may or may not take this information into account when configuring the UE using any of the described alternatives.

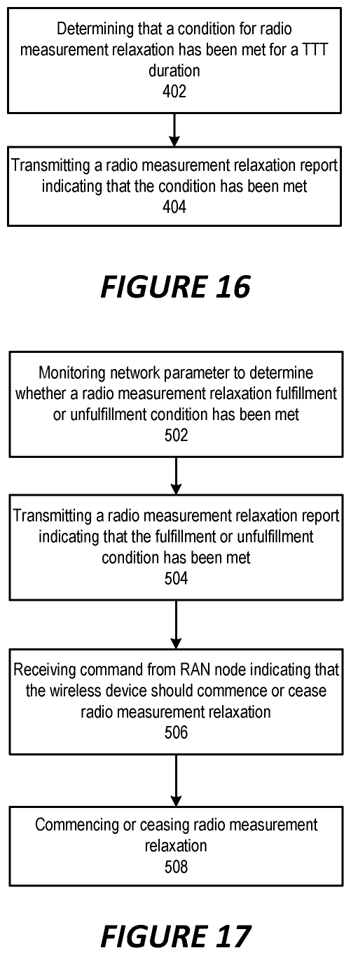

Operations of a wireless communication device/UE according to some embodiments are illustrated in the flowcharts of FIGS. 16-18.

Referring to FIG. 16, a method of operating a wireless device (20) in a communication network includes determining (402) that a condition for radio measurement relaxation, such as radio resource management, RRM, measurement relaxation, has been met for a continuous time to trigger, TTT, duration, wherein the continuous TTT duration is greater than zero, and in response to determining that the criterion for radio measurement relaxation has been met for the continuous TTT duration, transmitting (404) a radio measurement relaxation report to a radio access network, RAN, node (10) indicating that the condition for radio measurement relaxation has been met.

Referring to FIG. 17, a method of operating a wireless device (20) in a communication network includes monitoring (502) a network parameter to determine whether a fulfillment condition or an unfulfillment condition for radio measurement relaxation, such as radio resource management, RRM, measurement relaxation, has been met and transmitting (504) a radio measurement relaxation report to a network node in response to determining that the fulfillment condition or the unfulfillment condition has been met. The fulfillment condition may include the network parameter being greater than a first threshold, and the unfulfillment condition may include the network parameter being less than a second threshold, wherein the first threshold is greater than the second threshold.

The method may further include, in response to transmitting the report, receiving (506) a command from the RAN node indicating that the wireless device should cease radio measurement relaxation, and ceasing (508) radio measurement relaxation in response to receiving the command.

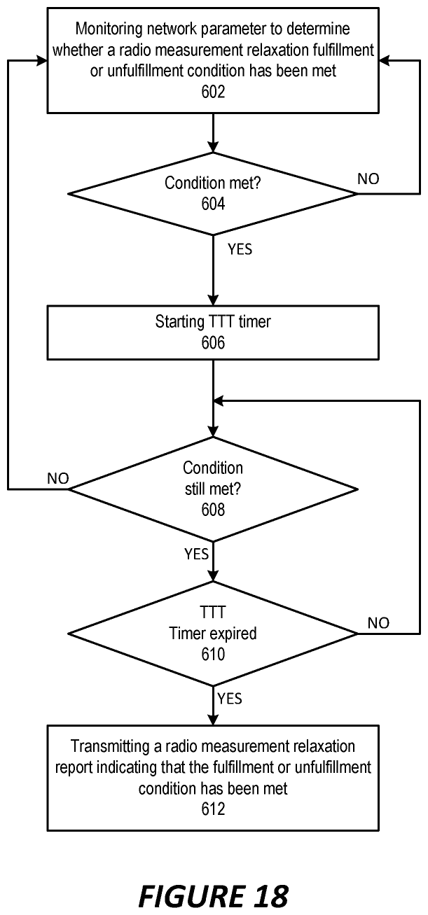

Referring to FIG. 18, a method of operating a wireless device (20) in a communication network includes monitoring (602) a network parameter to determine whether a fulfillment condition or an unfulfillment condition for radio measurement relaxation, such as radio resource management, RRM, measurement relaxation has been met. A determination of whether the condition has been met is made at block 604. In response to determining that the fulfillment condition or the unfulfillment condition has been met, the wireless device starts (606) a time-to-trigger, TTT, timer, and continues to monitor the condition at block 608. If the condition is no longer met, operations return to block 602 for monitoring.

If the condition is still met, the TTT timer is checked at block 610. If the TTT timer has expired and the condition is still met, the wireless device transmits a radio measurement relaxation report to the network indicating that the fulfillment or unfulfillment condition has been met.

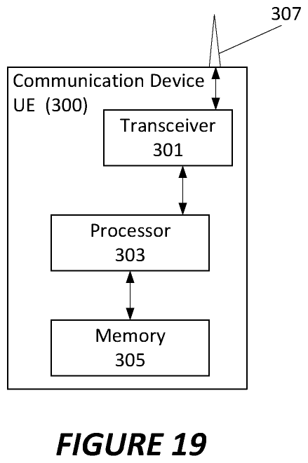

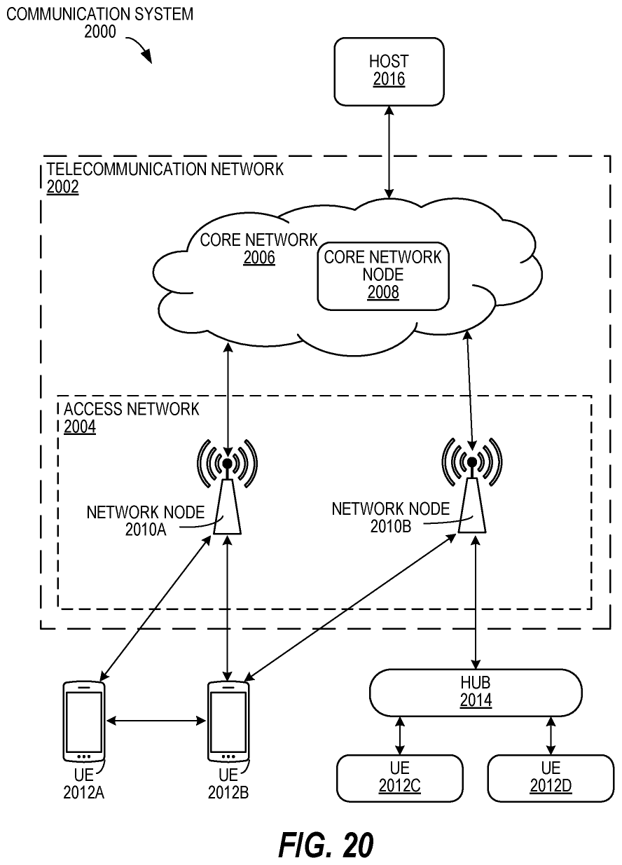

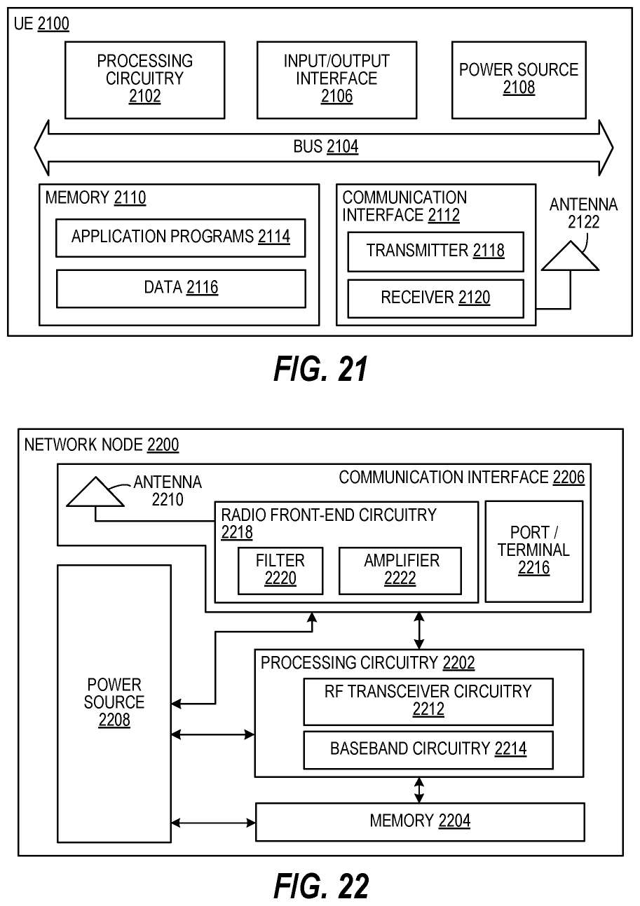

FIG. 19 is a block diagram illustrating elements of a communication device UE 300 (also referred to as a mobile terminal, a mobile communication terminal, a wireless device, a wireless communication device, a wireless terminal, mobile device, a wireless communication terminal, user equipment, UE, a user equipment node/terminal/device, etc.) configured to provide wireless communication according to embodiments of inventive concepts. (Communication device 300 may be provided, for example, as discussed below with respect to wireless device 202 of FIG. 20 and/or UE 2100 of FIG. 21. As shown, communication device UE may include an antenna 307 (e.g., corresponding to antenna 2122 of FIG. 21), and transceiver circuitry 301 (also referred to as a transceiver, e.g., corresponding to interface 2112 of FIG. 21) including a transmitter and a receiver configured to provide uplink and downlink radio communications with a base station(s) (e.g., corresponding to network node 2010A of FIG. 20, also referred to as a RAN node) of a radio access network. Communication device UE may also include processing circuitry 303 (also referred to as a processor, e.g., corresponding to processing circuitry 2102 of FIG. 21) coupled to the transceiver circuitry, and memory circuitry 305 (also referred to as memory, e.g., corresponding to device readable medium 2110 of FIG. 21) coupled to the processing circuitry. The memory circuitry 305 may include computer readable program code that when executed by the processing circuitry 303 causes the processing circuitry to perform operations according to embodiments disclosed herein. According to other embodiments, processing circuitry 303 may be defined to include memory so that separate memory circuitry is not required. Communication device UE may also include an interface (such as a user interface) coupled with processing circuitry 303, and/or communication device UE may be incorporated in a vehicle.

As discussed herein, operations of communication device UE may be performed by processing circuitry 303 and/or transceiver circuitry 301. For example, processing circuitry 303 may control transceiver circuitry 301 to transmit communications through transceiver circuitry 301 over a radio interface to a radio access network node (also referred to as a base station) and/or to receive communications through transceiver circuitry 301 from a RAN node over a radio interface. Moreover, modules may be stored in memory circuitry 305, and these modules may provide instructions so that when instructions of a module are executed by processing circuitry 303, processing circuitry 303 performs respective operations (e.g., operations discussed below with respect to Example Embodiments relating to wireless communication devices). According to some embodiments, a communication device UE 300 and/or an element(s)/function(s) thereof may be embodied as a virtual node/nodes and/or a virtual machine/machines.

FIG. 20 shows an example of a communication system 2000 in accordance with some embodiments.

In the example, the communication system 2000 includes a telecommunication network 2002 that includes an access network 2004, such as a radio access network (RAN), and a core network 2006, which includes one or more core network nodes 2008. The access network 2004 includes one or more access network nodes, such as network nodes 2010a and 2010b (one or more of which may be generally referred to as network nodes 2010), or any other similar 3rd Generation Partnership Project (3GPP) access node or non-3GPP access point. The network nodes 2010 facilitate direct or indirect connection of user equipment (UE), such as by connecting UEs 2012a, 2012b, 2012c, and 2012d (one or more of which may be generally referred to as UEs 2012) to the core network 2006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2000 may include any number of wired or wireless networks, network nodes, UEs, and/or any other components or systems that may facilitate or participate in the communication of data and/or signals whether via wired or wireless connections. The communication system 2000 may include and/or interface with any type of communication, telecommunication, data, cellular, radio network, and/or other similar type of system.

The UEs 2012 may be any of a wide variety of communication devices, including wireless devices arranged, configured, and/or operable to communicate wirelessly with the network nodes 2010 and other communication devices. Similarly, the network nodes 2010 are arranged, capable, configured, and/or operable to communicate directly or indirectly with the UEs 2012 and/or with other network nodes or equipment in the telecommunication network 2002 to enable and/or provide network access, such as wireless network access, and/or to perform other functions, such as administration in the telecommunication network 2002.

In the depicted example, the core network 2006 connects the network nodes 2010 to one or more hosts, such as host 2016. These connections may be direct or indirect via one or more intermediary networks or devices. In other examples, network nodes may be directly coupled to hosts. The core network 2006 includes one more core network nodes (e.g., core network node 2008) that are structured with hardware and software components. Features of these components may be substantially similar to those described with respect to the UEs, network nodes, and/or hosts, such that the descriptions thereof are generally applicable to the corresponding components of the core network node 2008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2016 may be under the ownership or control of a service provider other than an operator or provider of the access network 2004 and/or the telecommunication network 2002, and may be operated by the service provider or on behalf of the service provider. The host 2016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2000 of FIG. 20 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2002 is a cellular network that implements 3GPP standardized features. Accordingly, the telecommunications network 2002 may support network slicing to provide different logical networks to different devices that are connected to the telecommunication network 2002. For example, the telecommunications network 2002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2012 are configured to transmit and/or receive information without direct human interaction. For instance, a UE may be designed to transmit information to the access network 2004 on a predetermined schedule, when triggered by an internal or external event, or in response to requests from the access network 2004. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 2014 communicates with the access network 2004 to facilitate indirect communication between one or more UEs (e.g., UE 2012c and/or 2012d) and network nodes (e.g., network node 2010b). In some examples, the hub 2014 may be a controller, router, content source and analytics, or any of the other communication devices described herein regarding UEs. For example, the hub 2014 may be a broadband router enabling access to the core network 2006 for the UEs. As another example, the hub 2014 may be a controller that sends commands or instructions to one or more actuators in the UEs. Commands or instructions may be received from the UEs, network nodes 2010, or by executable code, script, process, or other instructions in the hub 2014. As another example, the hub 2014 may be a data collector that acts as temporary storage for UE data and, in some embodiments, may perform analysis or other processing of the data. As another example, the hub 2014 may be a content source. For example, for a UE that is a VR headset, display, loudspeaker or other media delivery device, the hub 2014 may retrieve VR assets, video, audio, or other media or data related to sensory information via a network node, which the hub 2014 then provides to the UE either directly, after performing local processing, and/or after adding additional local content. In still another example, the hub 2014 acts as a proxy server or orchestrator for the UEs, in particular in if one or more of the UEs are low energy IoT devices.

The hub 2014 may have a constant/persistent or intermittent connection to the network node 2010b. The hub 2014 may also allow for a different communication scheme and/or schedule between the hub 2014 and UEs (e.g., UE 2012c and/or 2012d), and between the hub 2014 and the core network 2006. In other examples, the hub 2014 is connected to the core network 2006 and/or one or more UEs via a wired connection. Moreover, the hub 2014 may be configured to connect to an M2M service provider over the access network 2004 and/or to another UE over a direct connection. In some scenarios, UEs may establish a wireless connection with the network nodes 2010 while still connected via the hub 2014 via a wired or wireless connection. In some embodiments, the hub 2014 may be a dedicated hub—that is, a hub whose primary function is to route communications to/from the UEs from/to the network node 2010b. In other embodiments, the hub 2014 may be a non-dedicated hub—that is, a device which is capable of operating to route communications between the UEs and network node 2010b, but which is additionally capable of operating as a communication start and/or end point for certain data channels.

FIG. 21 shows a UE 2100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2100 includes processing circuitry 2102 that is operatively coupled via a bus 2104 to an input/output interface 2106, a power source 2108, a memory 2110, a communication interface 2112, and/or any other component, or any combination thereof. Certain UEs may utilize all or a subset of the components shown in FIG. 21. The level of integration between the components may vary from one UE to another UE. Further, certain UEs may contain multiple instances of a component, such as multiple processors, memories, transceivers, transmitters, receivers, etc.

The processing circuitry 2102 is configured to process instructions and data and may be configured to implement any sequential state machine operative to execute instructions stored as machine-readable computer programs in the memory 2110. The processing circuitry 2102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2102 may include multiple central processing units (CPUs).

In the example, the input/output interface 2106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2108 is structured as a battery or battery pack. Other types of power sources, such as an external power source (e.g., an electricity outlet), photovoltaic device, or power cell, may be used. The power source 2108 may further include power circuitry for delivering power from the power source 2108 itself, and/or an external power source, to the various parts of the UE 2100 via input circuitry or an interface such as an electrical power cable. Delivering power may be, for example, for charging of the power source 2108. Power circuitry may perform any formatting, converting, or other modification to the power from the power source 2108 to make the power suitable for the respective components of the UE 2100 to which power is supplied.

The memory 2110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2110 includes one or more application programs 2114, such as an operating system, web browser application, a widget, gadget engine, or other application, and corresponding data 2116. The memory 2110 may store, for use by the UE 2100, any of a variety of various operating systems or combinations of operating systems.

The memory 2110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2110 may allow the UE 2100 to access instructions, application programs and the like, stored on transitory or non-transitory memory media, to off-load data, or to upload data. An article of manufacture, such as one utilizing a communication system may be tangibly embodied as or in the memory 2110, which may be or comprise a device-readable storage medium.

The processing circuitry 2102 may be configured to communicate with an access network or other network using the communication interface 2112. The communication interface 2112 may comprise one or more communication subsystems and may include or be communicatively coupled to an antenna 2122. The communication interface 2112 may include one or more transceivers used to communicate, such as by communicating with one or more remote transceivers of another device capable of wireless communication (e.g., another UE or a network node in an access network). Each transceiver may include a transmitter 2118 and/or a receiver 2120 appropriate to provide network communications (e.g., optical, electrical, frequency allocations, and so forth). Moreover, the transmitter 2118 and receiver 2120 may be coupled to one or more antennas (e.g., antenna 2122) and may share circuit components, software or firmware, or alternatively be implemented separately.

In the illustrated embodiment, communication functions of the communication interface 2112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2100 shown in FIG. 21.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 22 shows a network node 2200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 2200 includes a processing circuitry 2202, a memory 2204, a communication interface 2206, and a power source 2208. The network node 2200 may be composed of multiple physically separate components (e.g., a NodeB component and a RNC component, or a BTS component and a BSC component, etc.), which may each have their own respective components. In certain scenarios in which the network node 2200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 2200 may be configured to support multiple radio access technologies (RATs). In such embodiments, some components may be duplicated (e.g., separate memory 2204 for different RATs) and some components may be reused (e.g., a same antenna 2210 may be shared by different RATs). The network node 2200 may also include multiple sets of the various illustrated components for different wireless technologies integrated into network node 2200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2200.

The processing circuitry 2202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2200 components, such as the memory 2204, to provide network node 2200 functionality.

In some embodiments, the processing circuitry 2202 includes a system on a chip (SOC). In some embodiments, the processing circuitry 2202 includes one or more of radio frequency (RF) transceiver circuitry 2212 and baseband processing circuitry 2214. In some embodiments, the radio frequency (RF) transceiver circuitry 2212 and the baseband processing circuitry 2214 may be on separate chips (or sets of chips), boards, or units, such as radio units and digital units. In alternative embodiments, part or all of RF transceiver circuitry 2212 and baseband processing circuitry 2214 may be on the same chip or set of chips, boards, or units.

The memory 2204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 2202. The memory 2204 may store any suitable instructions, data, or information, including a computer program, software, an application including one or more of logic, rules, code, tables, and/or other instructions capable of being executed by the processing circuitry 2202 and utilized by the network node 2200. The memory 2204 may be used to store any calculations made by the processing circuitry 2202 and/or any data received via the communication interface 2206. In some embodiments, the processing circuitry 2202 and memory 2204 is integrated.

The communication interface 2206 is used in wired or wireless communication of signaling and/or data between a network node, access network, and/or UE. As illustrated, the communication interface 2206 comprises port(s)/terminal(s) 2216 to send and receive data, for example to and from a network over a wired connection. The communication interface 2206 also includes radio front-end circuitry 2218 that may be coupled to, or in certain embodiments a part of, the antenna 2210. Radio front-end circuitry 2218 comprises filters 2220 and amplifiers 2222. The radio front-end circuitry 2218 may be connected to an antenna 2210 and processing circuitry 2202. The radio front-end circuitry may be configured to condition signals communicated between antenna 2210 and processing circuitry 2202. The radio front-end circuitry 2218 may receive digital data that is to be sent out to other network nodes or UEs via a wireless connection. The radio front-end circuitry 2218 may convert the digital data into a radio signal having the appropriate channel and bandwidth parameters using a combination of filters 2220 and/or amplifiers 2222. The radio signal may then be transmitted via the antenna 2210. Similarly, when receiving data, the antenna 2210 may collect radio signals which are then converted into digital data by the radio front-end circuitry 2218. The digital data may be passed to the processing circuitry 2202. In other embodiments, the communication interface may comprise different components and/or different combinations of components.

In certain alternative embodiments, the network node 2200 does not include separate radio front-end circuitry 2218, instead, the processing circuitry 2202 includes radio front-end circuitry and is connected to the antenna 2210. Similarly, in some embodiments, all or some of the RF transceiver circuitry 2212 is part of the communication interface 2206. In still other embodiments, the communication interface 2206 includes one or more ports or terminals 2216, the radio front-end circuitry 2218, and the RF transceiver circuitry 2212, as part of a radio unit (not shown), and the communication interface 2206 communicates with the baseband processing circuitry 2214, which is part of a digital unit (not shown).

The antenna 2210 may include one or more antennas, or antenna arrays, configured to send and/or receive wireless signals. The antenna 2210 may be coupled to the radio front-end circuitry 2218 and may be any type of antenna capable of transmitting and receiving data and/or signals wirelessly. In certain embodiments, the antenna 2210 is separate from the network node 2200 and connectable to the network node 2200 through an interface or port.

The antenna 2210, communication interface 2206, and/or the processing circuitry 2202 may be configured to perform any receiving operations and/or certain obtaining operations described herein as being performed by the network node. Any information, data and/or signals may be received from a UE, another network node and/or any other network equipment. Similarly, the antenna 2210, the communication interface 2206, and/or the processing circuitry 2202 may be configured to perform any transmitting operations described herein as being performed by the network node. Any information, data and/or signals may be transmitted to a UE, another network node and/or any other network equipment.

The power source 2208 provides power to the various components of network node 2200 in a form suitable for the respective components (e.g., at a voltage and current level needed for each respective component). The power source 2208 may further comprise, or be coupled to, power management circuitry to supply the components of the network node 2200 with power for performing the functionality described herein. For example, the network node 2200 may be connectable to an external power source (e.g., the power grid, an electricity outlet) via an input circuitry or interface such as an electrical cable, whereby the external power source supplies power to power circuitry of the power source 2208. As a further example, the power source 2208 may comprise a source of power in the form of a battery or battery pack which is connected to, or integrated in, power circuitry. The battery may provide backup power should the external power source fail.

Embodiments of the network node 2200 may include additional components beyond those shown in FIG. 22 for providing certain aspects of the network node's functionality, including any of the functionality described herein and/or any functionality necessary to support the subject matter described herein. For example, the network node 2200 may include user interface equipment to allow input of information into the network node 2200 and to allow output of information from the network node 2200. This may allow a user to perform diagnostic, maintenance, repair, and other administrative functions for the network node 2200.

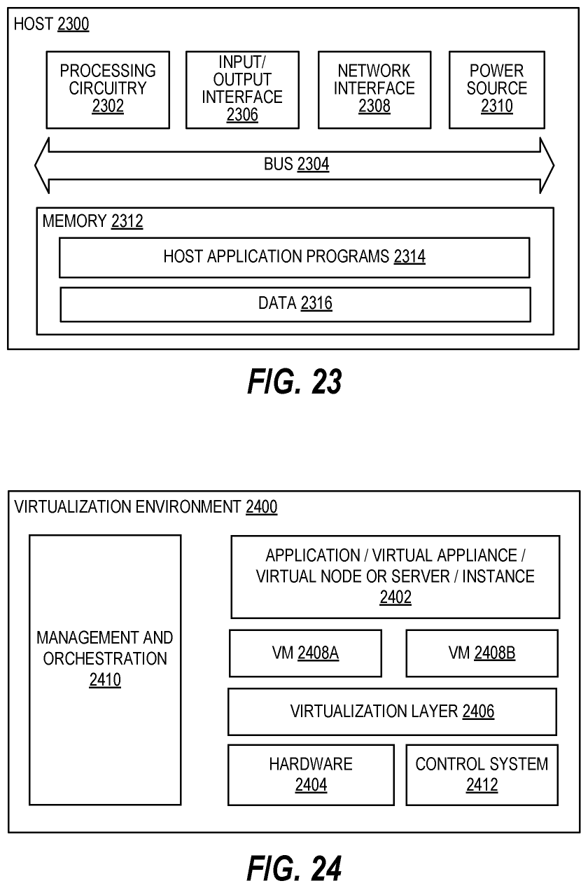

FIG. 23 is a block diagram of a host 2300, which may be an embodiment of the host 2016 of FIG. 20, in accordance with various aspects described herein. As used herein, the host 2300 may be or comprise various combinations hardware and/or software, including a standalone server, a blade server, a cloud-implemented server, a distributed server, a virtual machine, container, or processing resources in a server farm. The host 2300 may provide one or more services to one or more UEs.

The host 2300 includes processing circuitry 2302 that is operatively coupled via a bus 2304 to an input/output interface 2306, a network interface 2308, a power source 2310, and a memory 2312. Other components may be included in other embodiments. Features of these components may be substantially similar to those described with respect to the devices of previous figures, such as FIGS. 21 and 22, such that the descriptions thereof are generally applicable to the corresponding components of host 2300.

The memory 2312 may include one or more computer programs including one or more host application programs 2314 and data 2316, which may include user data, e.g., data generated by a UE for the host 2300 or data generated by the host 2300 for a UE. Embodiments of the host 2300 may utilize only a subset or all of the components shown. The host application programs 2314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2314 may also provide for user authentication and licensing checks and may periodically report health, routes, and content availability to a central node, such as a device in or on the edge of a core network. Accordingly, the host 2300 may select and/or indicate a different host for over-the-top services for a UE. The host application programs 2314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 24 is a block diagram illustrating a virtualization environment 2400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2402 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2406 (also referred to as hypervisors or virtual machine monitors (VMMs)), provide VMs 2408a and 2408b (one or more of which may be generally referred to as VMs 2408), and/or perform any of the functions, features and/or benefits described in relation with some embodiments described herein. The virtualization layer 2406 may present a virtual operating platform that appears like networking hardware to the VMs 2408.

The VMs 2408 comprise virtual processing, virtual memory, virtual networking or interface and virtual storage, and may be run by a corresponding virtualization layer 2406. Different embodiments of the instance of a virtual appliance 2402 may be implemented on one or more of VMs 2408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2408 may be a software implementation of a physical machine that runs programs as if they were executing on a physical, non-virtualized machine. Each of the VMs 2408, and that part of hardware 2404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2408 on top of the hardware 2404 and corresponds to the application 2402.

Hardware 2404 may be implemented in a standalone network node with generic or specific components. Hardware 2404 may implement some functions via virtualization. Alternatively, hardware 2404 may be part of a larger cluster of hardware (e.g. such as in a data center or CPE) where many hardware nodes work together and are managed via management and orchestration 2410, which, among others, oversees lifecycle management of applications 2402. In some embodiments, hardware 2404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2412 which may alternatively be used for communication between hardware nodes and radio units.

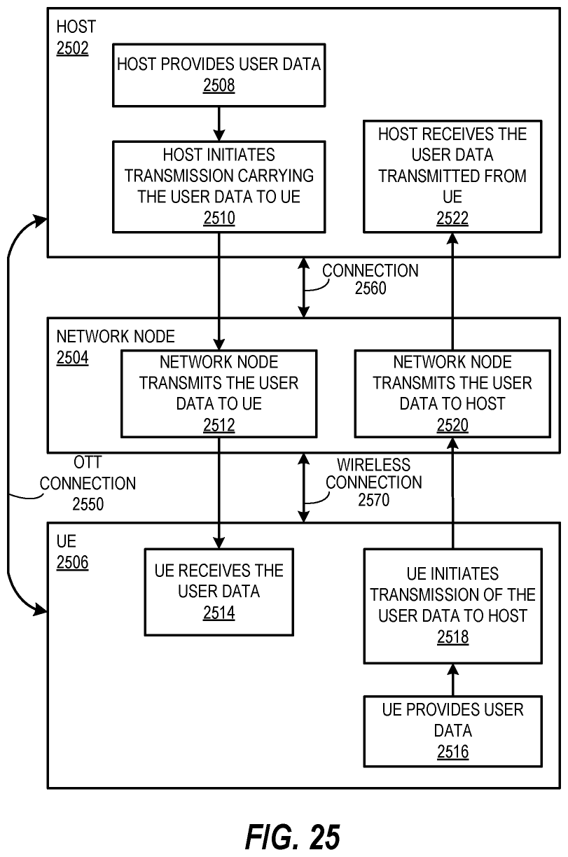

FIG. 25 shows a communication diagram of a host 2502 communicating via a network node 2504 with a UE 2506 over a partially wireless connection in accordance with some embodiments. Example implementations, in accordance with various embodiments, of the UE (such as a UE 2012a of FIG. 20 and/or UE 2100 of FIG. 21), network node (such as network node 2010a of FIG. 20 and/or network node 2200 of FIG. 22), and host (such as host 2016 of FIG. 20 and/or host 2300 of FIG. 23) discussed in the preceding paragraphs will now be described with reference to FIG. 25.

Like host 2300, embodiments of host 2502 include hardware, such as a communication interface, processing circuitry, and memory. The host 2502 also includes software, which is stored in or accessible by the host 2502 and executable by the processing circuitry. The software includes a host application that may be operable to provide a service to a remote user, such as the UE 2506 connecting via an over-the-top (OTT) connection 2550 extending between the UE 2506 and host 2502. In providing the service to the remote user, a host application may provide user data which is transmitted using the OTT connection 2550.

The network node 2504 includes hardware enabling it to communicate with the host 2502 and UE 2506. The connection 2560 may be direct or pass through a core network (like core network 2006 of FIG. 20) and/or one or more other intermediate networks, such as one or more public, private, or hosted networks. For example, an intermediate network may be a backbone network or the Internet.

The UE 2506 includes hardware and software, which is stored in or accessible by UE 2506 and executable by the UE's processing circuitry. The software includes a client application, such as a web browser or operator-specific “app” that may be operable to provide a service to a human or non-human user via UE 2506 with the support of the host 2502. In the host 2502, an executing host application may communicate with the executing client application via the OTT connection 2550 terminating at the UE 2506 and host 2502. In providing the service to the user, the UE's client application may receive request data from the host's host application and provide user data in response to the request data. The OTT connection 2550 may transfer both the request data and the user data. The UE's client application may interact with the user to generate the user data that it provides to the host application through the OTT connection 2550.

The OTT connection 2550 may extend via a connection 2560 between the host 2502 and the network node 2504 and via a wireless connection 2570 between the network node 2504 and the UE 2506 to provide the connection between the host 2502 and the UE 2506. The connection 2560 and wireless connection 2570, over which the OTT connection 2550 may be provided, have been drawn abstractly to illustrate the communication between the host 2502 and the UE 2506 via the network node 2504, without explicit reference to any intermediary devices and the precise routing of messages via these devices.

As an example of transmitting data via the OTT connection 2550, in step 2508, the host 2502 provides user data, which may be performed by executing a host application. In some embodiments, the user data is associated with a particular human user interacting with the UE 2506. In other embodiments, the user data is associated with a UE 2506 that shares data with the host 2502 without explicit human interaction. In step 2510, the host 2502 initiates a transmission carrying the user data towards the UE 2506. The host 2502 may initiate the transmission responsive to a request transmitted by the UE 2506. The request may be caused by human interaction with the UE 2506 or by operation of the client application executing on the UE 2506. The transmission may pass via the network node 2504, in accordance with the teachings of the embodiments described throughout this disclosure. Accordingly, in step 2512, the network node 2504 transmits to the UE 2506 the user data that was carried in the transmission that the host 2502 initiated, in accordance with the teachings of the embodiments described throughout this disclosure. In step 2514, the UE 2506 receives the user data carried in the transmission, which may be performed by a client application executed on the UE 2506 associated with the host application executed by the host 2502.

In some examples, the UE 2506 executes a client application which provides user data to the host 2502. The user data may be provided in reaction or response to the data received from the host 2502. Accordingly, in step 2516, the UE 2506 may provide user data, which may be performed by executing the client application. In providing the user data, the client application may further consider user input received from the user via an input/output interface of the UE 2506. Regardless of the specific manner in which the user data was provided, the UE 2506 initiates, in step 2518, transmission of the user data towards the host 2502 via the network node 2504. In step 2520, in accordance with the teachings of the embodiments described throughout this disclosure, the network node 2504 receives user data from the UE 2506 and initiates transmission of the received user data towards the host 2502. In step 2522, the host 2502 receives the user data carried in the transmission initiated by the UE 2506.

One or more of the various embodiments improve the performance of OTT services provided to the UE 2506 using the OTT connection 2550, in which the wireless connection 2570 forms the last segment. More precisely, the teachings of these embodiments may improve the power and/or resource consumption of a UE and thereby provide benefits such as increased battery life, reduced network utilization, and/or increased network capacity among others.

In an example scenario, factory status information may be collected and analyzed by the host 2502. As another example, the host 2502 may process audio and video data which may have been retrieved from a UE for use in creating maps. As another example, the host 2502 may collect and analyze real-time data to assist in controlling vehicle congestion (e.g., controlling traffic lights). As another example, the host 2502 may store surveillance video uploaded by a UE. As another example, the host 2502 may store or control access to media content such as video, audio, VR or AR which it can broadcast, multicast or unicast to UEs. As other examples, the host 2502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2550 between the host 2502 and UE 2506, in response to variations in the measurement results. The measurement procedure and/or the network functionality for reconfiguring the OTT connection may be implemented in software and hardware of the host 2502 and/or UE 2506. In some embodiments, sensors (not shown) may be deployed in or in association with other devices through which the OTT connection 2550 passes; the sensors may participate in the measurement procedure by supplying values of the monitored quantities exemplified above, or supplying values of other physical quantities from which software may compute or estimate the monitored quantities. The reconfiguring of the OTT connection 2550 may include message format, retransmission settings, preferred routing etc.; the reconfiguring need not directly alter the operation of the network node 2504. Such procedures and functionalities may be known and practiced in the art. In certain embodiments, measurements may involve proprietary UE signaling that facilitates measurements of throughput, propagation times, latency and the like, by the host 2502. The measurements may be implemented in that software causes messages to be transmitted, in particular empty or ‘dummy’ messages, using the OTT connection 2550 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method of operating a wireless device in a communication network, comprising:
determining that a criterion associated with radio measurement relaxation has been met for a continuous time to trigger, TTT, duration, wherein the continuous TTT duration is greater than zero; and
in response to determining that the criterion associated with radio measurement relaxation has been met for the continuous TTT duration, transmitting a radio measurement relaxation report to a radio access network, RAN, node indicating that the criterion associated with radio measurement relaxation has been met.

2. The method of claim 1, wherein the radio measurement relaxation report is sent by the wireless device when the criterion has been fulfilled for a continuous period of time and when the wireless device has not previously sent a positive radio measurement relaxation report indicating fulfillment of the criterion or a radio measurement relaxation report that was most recently sent by the wireless device was a negative report indicating unfulfillment of the criterion.

3. The method of claim 1, wherein the criterion comprises a received power level and/or received quality level of a reference signal transmitted by the RAN node being greater than a threshold value.

4. The method of claim 1, further comprising, in response to transmitting the measurement relaxation report, receiving a command from the RAN node changing a measurement configuration of the UE.

5. The method of claim 1, further comprising, in response to transmitting the measurement relaxation report, receiving a command from the RAN node which indicates that the wireless device should commence radio measurement relaxation; and
commencing radio measurement relaxation in response to receiving the command.

6. The method of claim 5, wherein the command comprises a radio measurement relaxation configuration.

7. The method of claim 1, wherein transmitting the radio measurement relaxation report is only performed if a radio measurement relaxation report most recently transmitted by the wireless device indicated that the criterion was not fulfilled.

8. The method of claim 1, wherein transmitting the radio measurement relaxation report is only performed if the wireless device did not already transmit a previous radio measurement relaxation report indicating fulfillment of the criterion.

9. The method of claim 1, wherein the criterion comprises an unfulfillment criterion that indicates that the wireless device is in a state that is unsuitable for radio measurement relaxation.

10.-37. (canceled)

38. A user equipment, UE, comprising:
processing circuitry; and
memory coupled with the processing circuitry, wherein the memory includes instructions that when executed by the processing circuitry causes the UE to perform operations comprising:
determine that a criterion associated with radio measurement relaxation has been met for a continuous time to trigger, TTT, duration, wherein the continuous TTT duration is greater than zero; and
in response to determining that the criterion associated with radio measurement relaxation has been met for the continuous TTT duration, transmit a radio measurement relaxation report to a radio access network, RAN, node indicating that the criterion associated with radio measurement relaxation has been met.

39.-40. (canceled)

41. A computer program product comprising a non-transitory storage medium including program code to be executed by processing circuitry of a user equipment, UE, whereby execution of the program code causes the UE to perform operations according to claim 1.

42. The UE of claim 38, wherein the radio measurement relaxation report is sent by the wireless device when the criterion has been fulfilled for a continuous period of time and when the wireless device has not previously sent a positive radio measurement relaxation report indicating fulfillment of the criterion or a radio measurement relaxation report that was most recently sent by the wireless device was a negative report indicating unfulfillment of the criterion.

43. The UE of claim 38, wherein the radio measurement relaxation report is sent by the wireless device when the criterion has been fulfilled for a continuous period of time and when the wireless device has not previously sent a positive radio measurement relaxation report indicating fulfillment of the criterion or a radio measurement relaxation report that was most recently sent by the wireless device was a negative report indicating unfulfillment of the criterion.

44. The UE of claim 38, wherein the criterion comprises a received power level and/or received quality level of a reference signal transmitted by the RAN node being greater than a threshold value.

45. The UE of claim 38, wherein the memory includes instructions that when executed by the processing circuitry causes the UE to perform further operations comprising:
in response to transmitting the measurement relaxation report, receiving a command from the RAN node changing a measurement configuration of the UE.

46. The UE of claim 38, wherein the memory includes instructions that when executed by the processing circuitry causes the UE to perform further operations comprising:
in response to transmitting the measurement relaxation report, receive a command from the RAN node which indicates that the wireless device should commence radio measurement relaxation; and
commence radio measurement relaxation in response to receiving the command.

47. The UE of claim 46, wherein the command comprises a radio measurement relaxation configuration.

48. The UE of claim 38, wherein transmit the radio measurement relaxation report is only performed if a radio measurement relaxation report most recently transmitted by the wireless device indicated that the criterion was not fulfilled.

49. The UE of claim 38, wherein transmit the radio measurement relaxation report is only performed if the wireless device did not already transmit a previous radio measurement relaxation report indicating fulfillment of the criterion.
